(19) United States
(12) Patent Application Publication
(10) Pub. No.: US 2018/0137767 A1
(43) Pub. Date: May 17, 2018

(54) UAV HAVING RADAR-GUIDED LANDING FUNCTION, SYSTEM AND METHOD THEREOF

(71) Applicants: Yi Liang HOU, New Taipei City (TW); Yi Yin LEE, New Taipei City (TW)

(72) Inventors: Yi Liang HOU, New Taipei City (TW); Yi Yin LEE, New Taipei City (TW)

(21) Appl. No.: 15/809,999

(22) Filed: Nov. 10, 2017

(30) Foreign Application Priority Data
Nov. 11, 2016 (TW) 105136757

(51) Int. Cl. G08G 5/02; G01S 13/91; G05D 1/06; G08G 5/00; B64C 39/02

(52) U.S. Cl. CPC G08G 5/025; G01S 13/913; B64C 2201/18; G08G 5/0069; B64C 39/024; G05D 1/0676

(57) ABSTRACT

A UAV having a radar-guided landing function that helps the UAV to land on a landing station is disclosed. The UAV uses a GPS transceiving unit's positioning, and receives a flight path from an external source through a control unit to advance toward the landing station. When the UAV approaches a landing station, the control unit receives an activation signal and activates a landing radar to continuously transmit a frequency sweeping radar wave. When the frequency sweeping radar wave reaches the landing station, a reflected radar wave is generated, so that the landing radar receives the reflected radar wave and transmits it to the control unit. The control unit performs computation based on data related to the reflected radar wave and accordingly controls the UAV to land on the landing station.

### CROSS REFERENCE TO RELATED APPLICATIONS

This application claims the benefit of priority to Taiwan patent application no. 105136757, filed Nov. 11, 2016, the disclosure of which is hereby incorporated by reference in its entirety.

### BACKGROUND OF THE INVENTION

### 1. Technical Field

The present invention relates to unmanned aerial vehicles (UAVs), and more particular to a UAV having a radar-guided landing function, its system and its landing method.

### 2. Description of Related Art

At present, the positioning methods UAVs use for landing are most based on image recognition systems and require a sizeable area for UAV to land. Besides, a recognizable pattern or target has to be provided for such an image recognition system to guide a UAV to land accurately. Where the weather is bad or it is night, the landing accuracy can be significantly compromised.

Furthermore, for long-distance flight, a UAV may need recharging midway. This is done by engaging the UAV with a charging device provided at a particular site. When such a charging device is provided at a landing station or platform installed at a lamp post or a building roof, and the UAV lands less accurately due to bad weather or limited visibility, the UAV that has land may have difficulty in engaging with the charging device and the required charging can become impossible.

In addition, if there is unexpected obstacle appearing along a predetermined flight path, and the weather is bad or it is at night where the lighting condition is poor, the traditional image recognition systems may fail to enable the UAV to dodge timely, and in the worst case the UAV can be damaged due to collision.

### BRIEF SUMMARY OF THE INVENTION

To address the shortcomings of the prior art, the objective of the present invention is to provide a UAV having a radar-guided landing function, its UAV system and its landing method, which feature high landing accuracy.

For achieving the foregoing objective, the present invention provides a UAV having a radar-guided landing function, which comprises: a global positioning system (GPS) transceiving unit, for receiving and transmitting location information; a landing radar device, be activated during landing for positioning and measuring landing distance; a control unit, electrically connected to the GPS transceiving unit and the landing radar, respectively; wherein the UAV receives a flight path from an external source using positioning of the GPS transceiving unit through the control unit and advances toward a location of the landing station by following the flight path, when the UAV approaches the landing station, the control unit receiving an activation signal from an external source and activating the landing radar to continuously send out a frequency sweeping radar wave; when the frequency sweeping radar wave reaching the landing station, a reflected radar wave being generated, so that the landing radar receives the reflected radar wave and transmits the same to the control unit; the control unit performing computation based on data associated with the reflected radar wave and controlling the UAV to land on the landing station.

For achieving the foregoing objective, the present invention provides a UAV system having a radar-guided landing function, which comprises: a landing station, for continuously generating and sending out an activation signal; a UAV, comprising: a global positioning system (GPS) transceiving unit, for receiving and transmitting location information; a landing radar device, to be activated during landing for positioning and measuring landing distance; a control unit, electrically connected to the GPS transceiving unit and the landing radar, respectively; wherein the UAV receives a flight path from an external source using positioning of the GPS transceiving unit through the control unit and advances toward a location of the landing station by following the flight path; when the UAV approaches the landing station, the control unit receiving the activation signal from an external source and activating the landing radar to continuously send out a frequency sweeping radar wave; when the frequency sweeping radar wave reaching the landing station, a reflected radar wave being generated, so that the landing radar receives the reflected radar wave and transmits the same to the control unit; the control unit performing computation based on data associated with the reflected radar wave and controlling the UAV to land on the landing station.

For achieving the foregoing objective, the present invention provides a UAV radar-guided landing method, which comprises: setting up a flight path, which comprises at least one landing station for a UAV to land; guiding the UAV toward the landing station using a GPS transceiving unit, wherein the landing station continuously sends out an activation signal; when the UAV has received the activation signal, entering the UAV into a positioning mode where it continuously sends out a frequency sweeping radar wave; and when the UAV has received a reflected radar wave generated when the frequency sweeping radar wave hits the landing station, entering the UAV into a landing mode for its landing on the landing station.

### BRIEF DESCRIPTION OF THE SEVERAL VIEWS OF THE DRAWINGS

FIG. 1 is a schematic drawing of a UAV according to the present invention.

FIG. 2 is a block diagram of the UAV of the present invention.

FIG. 3 is a schematic drawing showing avoidance performed by the disclosed UAV using a Doppler radar.

FIG. 4 is a schematic drawing of landing station according to the present invention.

FIG. 5 is a schematic drawing showing the disclosed UAV landing on the landing station.

FIG. 6-1 through FIG. 6-3 show variation in received signal values of a reflected radar wave according to the present invention.

FIG. 7-1 and FIG. 7-2 show variation in received signal values of an activation signal according to the present invention.

FIG. 8 is a flow chart of a landing method of the present invention.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention.

Referring to FIG. 1, a UAV 10 of the present invention has a main body 12 and a flying mechanism 14. The flying mechanism in the present embodiment includes propellers that propel the main body 12 to fly, while other types of other aviatic propelling devices may be used in practice. The main body 12 is further provided with a GPS transceiving unit 1013, a Doppler radar 1015, an RF receiving unit 1018 and a landing radar 1016. Preferably, the Doppler radar 1015 is located at the lateral of the main body 12, and the landing radar 1016 is located below the main body 12.

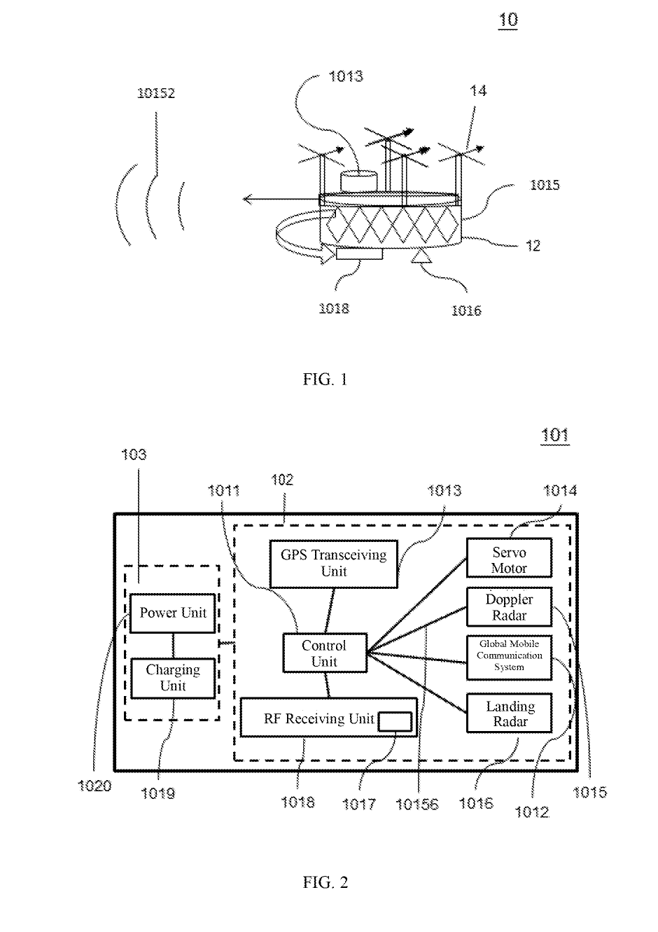

Please refer to FIG. 2 for a block diagram of the disclosed UAV. The control circuit 101 of the UAV comprises a detecting module 102 and a power module 103. The power module 103 power the detecting module 102 to operate. The detecting module 102 comprises a control unit 1011, a global mobile communication system 1012, a GPS transceiving unit 1013, a servo motor 1014, a Doppler radar 1015, a landing radar 1016, a signal strength detecting unit 1017, an RF receiving unit 1018, a charging unit 1019, and a power unit 1020. The control unit 1011 is electrically connected to the global mobile communication system 1012, the GPS transceiving unit 1013, the servo motor 1014, the Doppler radar 1015, the landing radar 1016, the signal strength detecting unit 1017, and the RF receiving unit 1018, respectively. The power module 103 comprises a charging unit 1019 and a power unit 1020 electrically connected to the charging unit 1019. The charging unit 1019 may be a connector for external connection, and the power unit 1020 is preferably a lithium battery.

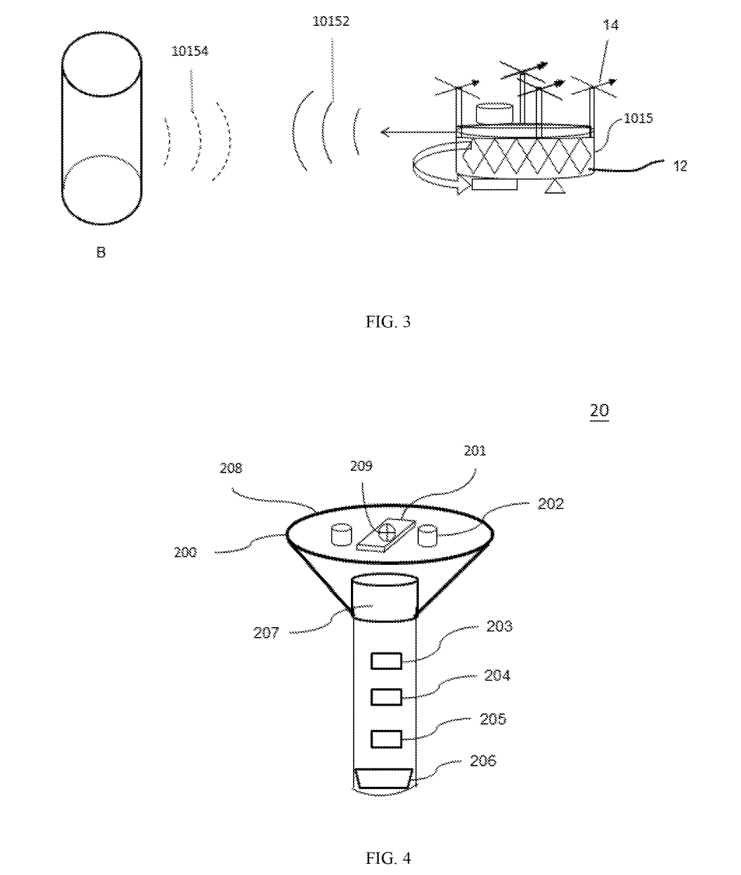

Further referring to FIG. 2 and FIG. 3, when the UAV 10 flies, the control unit 1011 makes it follow a flight path received from an external source, and has the GPS transceiving unit 1013 to perform positioning detection on the UAV 10, so as to make the UAV stick to its flight path. The Doppler radar 1015 at the lateral of the main body 12 transmits a detection signal 10152 toward the advancing direction of the UAV 10 when the UAV 10 flies. When there is an obstacle B in the advancing direction of the UAV 10, the detection signal 10152 when reaching the obstacle B generates a reflected signal 10154. When receiving the reflected signal 10154, the Doppler radar 1015 sends an avoidance signal 10156 to the control unit 1011, for the latter to control the UAV 10 to adjust its flight attitude for obstacle avoidance.

FIG. 4 depicts a landing station according to the present invention. The landing station 20 has a platform 200. The platform 200 has an RF transmitting unit 201, a positioning element 202, an energy storage unit 203, a landing station control unit 204, a memory unit 205, an external power connector 206, and a power detection device 207. The positioning element 202 is located above the platform for fixing the UAV to the platform 200. The external power connector 206 serves to draw mains electricity from the grid and store it in the energy storage unit 203 for the later use of the landing station 20. In the event of mains failure, the landing station 20 can use the electricity stored in the energy storage unit 203 to operate. Furthermore, a solar panel 208 may be added to the platform 200, so that in the event of mains failure, there is still power to be stored in the energy storage unit 203 for electricity storage.

Referring to FIG. 1 through FIG. 5 together, the landing station control unit 204 of the landing station 20 drives the RF transmitting unit 201 to transmit an activation signal 2012 in a certain time interval. Since the activation signal 2012 is transmitted outward in the form of a radar wave, it has a radiative range. When the UAV 10 follows the flight path and approaches the landing station 20 to the extent that it enters the radiative range of the activation signal 2012, the RF receiving unit 1018 of the UAV 10 receives the activation signal 2012 and notify the control unit 1011 to activate the landing radar 1016. The landing radar 1016 continuously sends a frequency sweeping radar wave 10162 in the landing direction continuously. When the frequency sweeping radar wave 10162 reaches the platform 200, a reflected radar wave 10164 is generated. The landing radar 1016 receives the reflected radar wave 10164 and transmits it to the control unit 1011. The control unit 1011 performs computation based on data associated with the reflected radar wave and controls the UAV 10 to land on the platform 200 of the landing station 20.

It is to be noted that the frequency sweeping radar wave 10162 includes plural signals with different frequencies in a certain frequency range. The frequency range is preferably between 0.5 MHz and 200 MHz. The landing radar 1016 may be a pulse radar or a radar of a different type. In one preferred embodiment, it may be a frequency modulated continuous wave (FMCW) radar. To generate a reflected radar wave 10164 with preferred signal strength, the platform 200 may be made of metal or any material that has a high dielectric constant.

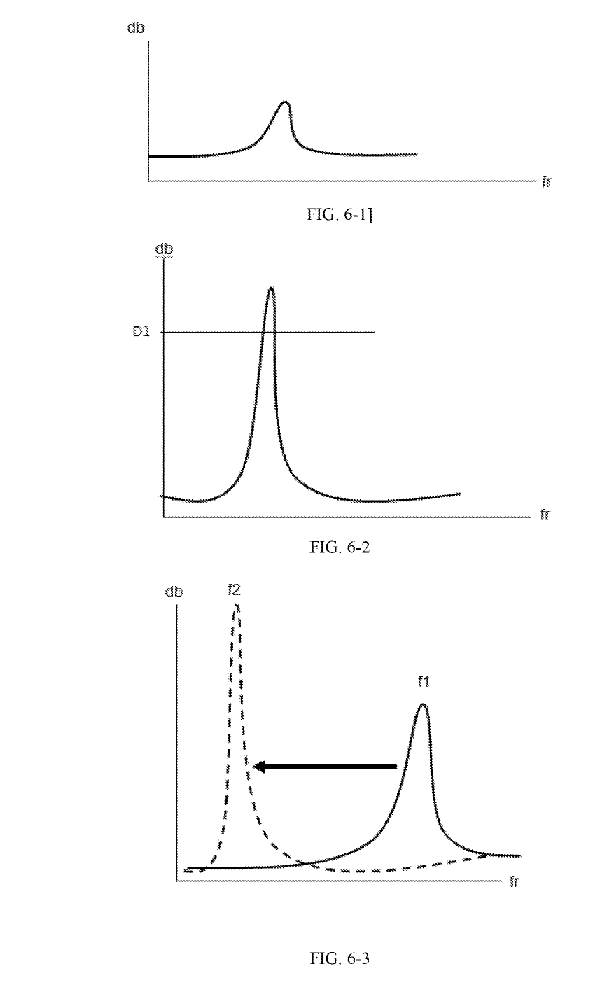

Referring to FIG. 4, FIG. 6-1 and FIG. 6-3, the reflected radar wave 10164 received by the landing radar 1016 varies proportionally with the area the frequency sweeping radar wave 10162 hits the platform 200. When the frequency sweeping radar wave 10162 only partially hits the platform 200, as shown in FIG. 6-1, the signal strength of the reflected radar wave 10164 is relatively weak. As the UAV keeps advancing toward the center of the platform, when the frequency sweeping radar wave 10162 hits the platform 200 fully, as shown in FIG. 6-2, the signal strength of the reflected radar wave 10164 is stronger than that shown in FIG. 6-1. When the signal strength of the reflected radar wave 10164 meets a first predetermined value D1, the control unit 1011 determines that the UAV 10 approaches the platform 200 from above but not at the periphery, so it starts the landing process to land the UAV 10 on the platform 200. As shown in FIG. 6-3, during landing, the signal waveform of the reflected radar wave 10164 shifts from a high-frequency signal waveform f1 to a low-frequency signal waveform f2, and the signal strength of the reflected radar wave 10164 increases gradually. When the signal waveform of the reflected radar wave 10164 stops changing or only changes slightly, the control unit 1011 stops the servo motor 1014, and in turn the flying mechanism 14 stops. Therein, the first predetermined value D1 is the maximum signal strength of the reflected radar wave 10164.

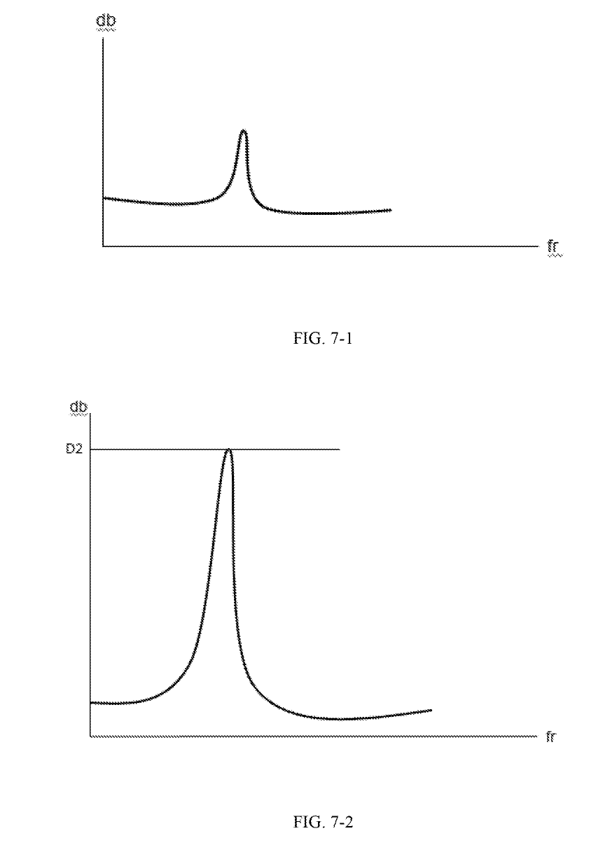

Further referring to FIG. 4, FIG. 7-1 and FIG. 7-2, when the UAV 10 enters the radiative range of the activation signal 2012, for enhancing the landing accuracy of the UAV 10, in addition to the landing radar 1016, variation in the signal strength of the activation signal 2012 received by the RF receiving unit 1018 due to the changing distance from the RF transmitting unit 201 is also used as a reference for the control unit 1011 of the UAV 10 to control the UAV 10 to fly to where the signal strength of the activation signal 2012 is strong until the second predetermined value D2 is met and the reflected radar wave 10164 meets the first predetermined value D1. At this time, the control unit 1011 enters its landing mode to control the UAV 10 to land on the landing station 20. When the UAV 10 is right above the RF transmitting unit 201, the signal strength received by the RF receiving unit 1018 is the strongest. In the present embodiment, the RF transmitting unit 201 is located at the center of the platform 200. It is to be noted that, for detecting the signal strength of the activation signal 2012, a signal strength detecting unit 1017 may be further provided. The signal strength detecting unit 1017 may be a separate circuit electrically connected to the RF receiving unit 1018. Alternatively, as shown in FIG. 2, the signal strength detecting unit 1017 may be a part of the RF receiving unit 1018.

Moreover, when the UAV 10 has landed on the platform 200, the positioning element 202 on the platform 200 may be used to secure the UAV 20 to the platform 200. The positioning element is preferably a magnetic induction coil. When the UAV 10 lands on the platform 200, the landing station control unit 204 of the landing station 20 energizes the positioning element 202 to generate a magnetic field, where the UAV 10 is secured to the platform 200 due to magnetic combination therebetween.

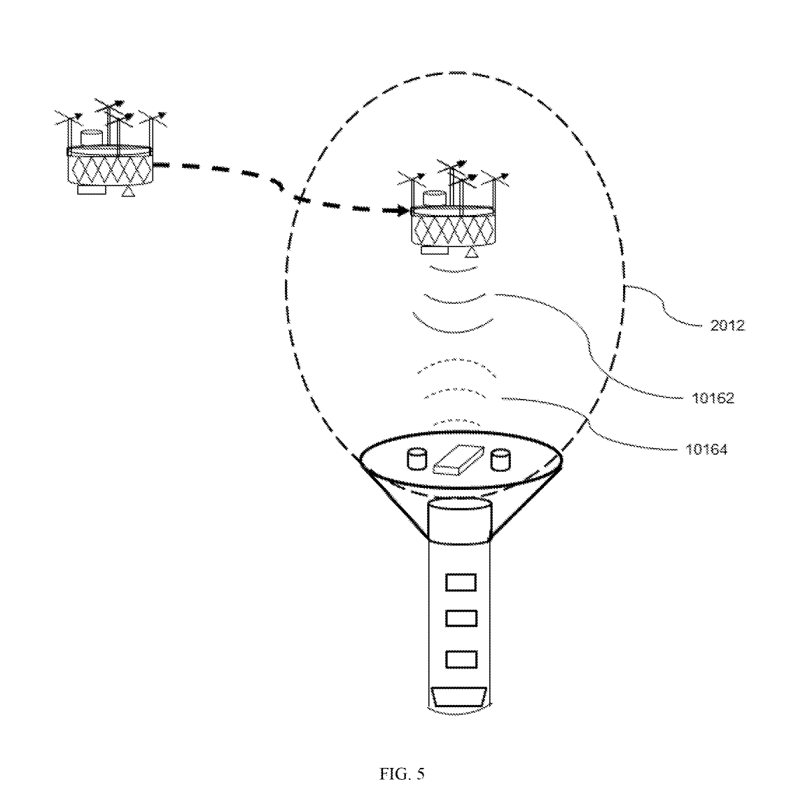

Now referring to FIG. 4 and FIG. 5, the platform 200 may further has a socket component 209. When UAV 10 has landed, the charging unit 1019 may be electrically connected to the socket component 209 and draw electricity from the landing station 20 to charge the power unit 1020 of the UAV 10. Preferably, electricity is drawn from the energy storage unit 203 of the landing station 20 or through an external power connector 206.

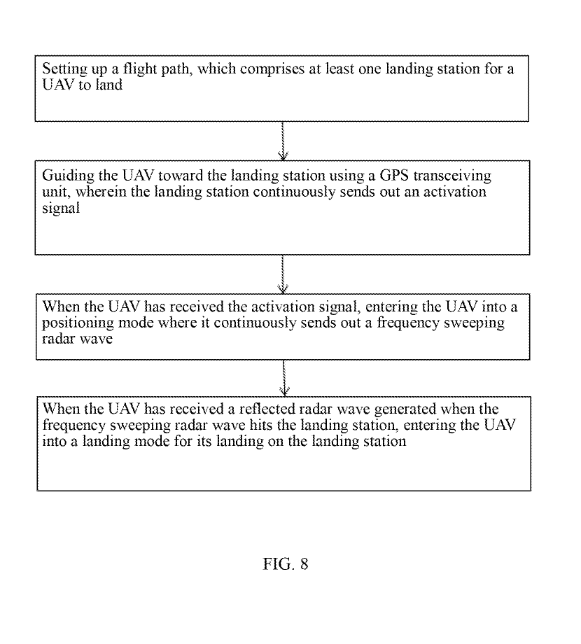

FIG. 8 is a flowchart of the landing method of the present invention. As shown, the disclosed radar-guided landing method for a UAV 10 comprises the following steps. First, a flight path is set up. The flight path comprises at least one landing station 20 where the UAV can land. Then a GPS transceiving unit 1013 is sued to guide the UAV 10 to fly toward the landing station 20. The landing station 20 continuously transmits an activation signal 2012 outward. When the UAV 10 receives the activation signal 2012 and enters a positioning mode, it continuously transmits the frequency sweeping radar wave 10162. Upon its receipt of the reflected radar wave 10164 generated when the frequency sweeping radar wave 10162 reached the platform 200 of the landing station 20, and the reflected radar wave 10164 meets the first predetermined value D1, the UAV 10 enters a landing mode where it lands on the landing station 20. When the signal waveform of the reflected radar wave 10164 finally stops changing or only changes slightly, it is confirmed that the UAV has finished its landing mode.

In addition to the reflected radar wave 10164, the UAV 10 may also use the activation signal 2012 for better landing accuracy. When the UAV 10 detects the activation signal 2012, it continuously detect the signal strength of the activation signal 2012, and flies toward where the signal strength high. When it detects that the signal strength of the activation signal 2012 meets a second predetermined value D2, and the reflected radar wave 10164 meets the first predetermined value D1, the UAV 10 enters its landing mode and lands on the landing station 20. The operations of and the similarity between the reflected radar wave 10164 and the activation signal 2012 are not described in detail herein.

Furthermore, during its flight, the UAV 10 may performs an avoidance operation where it transmits a detection signal 10152 in its flying direction, and when there is an obstacle B in its flying direction, the detection signal 10152 reaching the obstacle B generate a reflected signal 10154, so the UAV 10 receives the reflected signal 10154 and uses them in computation based on Doppler effect to avoid the obstacle B.

What is claimed is:

1. An unmanned aerial vehicle (UAV) having a radar-guided landing function, for landing on a landing station, the UAV comprising;
a global-positioning-system (GPS) transceiving unit, for receiving and transmitting location information;
a landing radar device, to be activated during landing for positioning and measuring landing distance;
a control unit, electrically connected to the GPS transceiving unit and the landing radar, respectively;
wherein the UAV receives a flight path from an external source using positioning of the GPS transceiving unit through the control unit and advances toward a location of the landing station by following the flight path; when the UAV approaches the landing station, the control unit receiving an activation signal from an external source and activating the landing radar to continuously send out a frequency sweeping radar wave; when the frequency sweeping radar wave reaching the landing station, a reflected radar wave being generated, so that the landing radar receives the reflected radar wave and transmits the same to the control unit; the control unit performing computation based on data associated with the reflected radar wave and controlling the UAV to land on the landing station.

2. The UAV of claim 1, further comprising an RF receiving unit, which is electrically connected to the control unit and serves to receive an activation signal from an external source, so that when receiving the activation signal, the RF receiving unit notifies the control unit to activate the landing radar.

3. The UAV of claim 1, further comprising a Doppler radar device, which is electrically connected to the control unit, wherein the Doppler radar device serves to send out a detection signal in a flying direction of the UAV, so that when the Doppler radar device receives a reflected signal originated from the detection signal, the Doppler radar device generates an avoidance signal to the control unit, which makes the control unit adjust the UAV's flight attitude and thereby performing obstacle avoidance.

4. The UAV of claim 1, wherein the landing radar is a pulse radar device.

5. The UAV of claim 1, wherein the landing radar is a frequency modulated continuous wave (FMCW) radar device.

6. A UAV system having a radar-guided landing function, comprising:
a landing station, for continuously generating and sending out an activation signal;
a UAV, comprising:
a global positioning system (GPS) transceiving unit, for receiving and transmitting location information;
a landing radar device, to be activated during landing for positioning and measuring landing distance;
a control unit, electrically connected to the GPS transceiving unit and the landing radar, respectively;
wherein the UAV receives a flight path from an external source using positioning of the GPS transceiving unit through the control unit and advances toward a location of the landing station by following the flight path; when the UAV approaches the landing station, the control unit receiving the activation signal from an external source and activating the landing radar to continuously send out a frequency sweeping radar wave; when the frequency sweeping radar wave reaching the landing station, a reflected radar wave being generated, so that the landing radar receives the reflected radar wave and transmits the same to the control unit; the control unit performing computation based on data associated with the reflected radar wave and controlling the UAV to land on the landing station.

7. The UAV system of claim 6, wherein the UAV further comprising an RF receiving unit, which is electrically connected to the control unit and serves to receive the activation signal and transmit the same to the control unit, so that when the control unit receives the activation signal, it activates the landing radar, wherein when the reflected radar wave's signal strength meets a first predetermined value, the control unit performs a landing process to make the UAV land on the landing station.

8. The UAV system of claim 7, wherein the control unit according to the activation signal's signal strength, controls the UAV to fly toward where the activation signal's strength is relatively strong, and when the activation signal's strength meets a second predetermined value, the control unit performs a landing process to make the UAV land on the landing station.

9. The UAV system of claim 6, wherein the activation signal is transmitted according to a time interval frequency.

10. The UAV system of claim 6, wherein the landing station further comprises an energy storage unit.

11. The UAV system of claim 6, wherein the landing station has one end thereof provided with a platform and a socket component located on the platform, in which the UAV lands on the platform and is connected to the socket component for charging.

12. The UAV system of claim 6, wherein the platform further has a positioning element, so that when the UAV lands on the platform, the positioning element and the UAV engage with each other, thereby securing the UAV to the platform.

13. The UAV system of claim 12, wherein the positioning element is a magnetic induction coil, so that when the UAV lands on the platform, the landing station energizes the positioning element to generate a magnetic field, thereby securing the UAV to the platform by means of magnetic combination.

14. A UAV radar-guided landing method, comprising:
setting up a flight path, which comprises at least one landing station for a UAV to land;
guiding the UAV toward the landing station using a GPS transceiving unit, wherein the landing station continuously sends out an activation signal;
when the UAV has received the activation signal, entering the UAV into a positioning mode where it continuously sends out a frequency sweeping radar wave; and
when the UAV has received a reflected radar wave generated when the frequency sweeping radar wave hits the landing station, entering the UAV into a landing mode for its landing on the landing station.

15. The landing method of claim 14, further comprising an avoidance mode, wherein the UAV sends out a detection signal in its flying direction, and when an obstacle appears in the flying direction, the detection signal hits the obstacle B and generates a reflected signal, so that the UAV when receiving the reflected signal performs computation to avoid the obstacle using the Doppler effect.

16. The landing method of claim 14, wherein when the reflected radar wave meets a first predetermined value, the UAV performs the landing mode and lands on the landing station.

17. The landing method of claim 16, wherein the UAV continuously detects the activation signal's strength, and flies toward where the signal's strength is relatively high, and when it detects that the activation signal's strength meet a second predetermined value, the UAV performs the landing mode and lands on the landing station.
